(19) United States
(12) Patent Application Publication
(10) Pub. No.: US 2023/0246241 A1
(43) Pub. Date: Aug. 3, 2023

(54) METHODS TO REDUCE INTERFACIAL RESISTANCE IN SOLID-STATE BATTERY

(71) Applicant: GM GLOBAL TECHNOLOGY OPERATIONS LLC, Detroit, MI (US)

(72) Inventors: Jung Hwi CHO, Providence, RI (US); Aijie CHEN, Northville, MI (US); Xingcheng XIAO, Troy, MI (US); Mei CAI, Warren, MI (US)

(73) Assignee: GM GLOBAL TECHNOLOGY OPERATIONS LLC, Detroit, MI (US)

(21) Appl. No.: 17/579,144

(22) Filed: Jan. 19, 2022

(51) Int. Cl. H01M 10/058; H01M 10/0525; H01M 4/134; H01M 4/04

(52) U.S. Cl. CPC H01M 10/058; H01M 4/134; H01M 4/0445; H01M 10/0525; H01M 2004/027; H01M 2300/0068

(57) ABSTRACT

A method for forming a solid-state battery includes preparing a cell, heating the cell to a first temperature, and cycling the cell while maintaining the cell at the first temperature and/or while the cell is cooled to room temperature from the first temperature. The cell includes a solid-state electrolyte adjacent to a negative electrode, including a negative electroactive material selected from the group consisting of: lithium metal, lithium alloys, silicon, silicon alloys, and combinations thereof. The first temperature is between about 50° C. and about 175° C. The cell is cycled for between about 1 cycle and about 10 cycles, where current densities are between about 0.01 mA/cm² and about 10 mA/cm², and capacity per cycle between about 0.01 mAh/cm² and about 1 mAh/cm².

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12 V start-stop systems), battery-assisted systems (“µBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which includes a solid-state electrolyte layer disposed between solid-state electrodes, the solid-state electrolyte physically separates the solid-state electrodes so that a distinct separator is not required.

Solid-state batteries have advantages over batteries that include a separator and a liquid electrolyte. These advantages can include a longer shelf life with lower self-discharge, simpler thermal management, a reduced need for packaging, and the ability to operate within a wider temperature window. For example, solid-state electrolytes are generally non-volatile and non-flammable, so as to allow cells to be cycled under harsher conditions without experiencing diminished potential or thermal runaway, which can potentially occur with the use of liquid electrolytes. However, interfacial resistance between a solid-state electrolyte and a lithium metal anode often leads to poor battery performance and/or cell failure. Common methods of improving such solid-solid interfaces (e.g. heat treatments at high temperatures and high stack pressures) are often cost prohibited. Accordingly, it would be desirable to develop materials and methods for making high-performance solid-state batteries that improve manufacturing processes.

### SUMMARY

This section provides a general summary of the disclosure, and is not a comprehensive disclosure of its full scope or all of its features.

The present disclosure relates to solid-state batteries, for example lithium-metal solid-state batteries, and methods of forming the same.

In various aspects, the present disclosure provides a method for forming a solid-state battery. The method includes preparing a cell, heating the cell to a first temperature, and cycling the cell while maintaining the cell at the first temperature and/or while the cell is cooled to room temperature from the first temperature. The cell includes a solid-state electrolyte adjacent to a negative electrode. The solid-state battery incorporating the cell may have a total resistance greater than or equal to about 0.01 Ohm-cm² to less than or equal to about 1,000 Ohm-cm².

In one aspect, the negative electrode may include one or more negative electroactive materials selected from the group consisting of: lithium metal, lithium alloys, silicon, silicon alloys, and combinations thereof.

In one aspect, the negative electrode includes a lithium-metal foil.

In one aspect, the first temperature may be greater than or equal to about 50° C. to less than or equal to about 175° C.

In one aspect, the cell may be cycled for greater than or equal to about 1 cycle to less than or equal to about 10 cycles.

In one aspect, while cycling, current densities may be greater than or equal to about 0.01 mA/cm² to less than or equal to about 10 mA/cm².

In one aspect, while cycling, capacity per cycle may be greater than or equal to about 0.01 mAh/cm² to less than or equal to about 1 mAh/cm².

In one aspect, the cell may be cycled while the cell is maintained at the first temperature. The cell may be maintained at the first temperature for a time period greater than or equal to about 30 minutes to less than or equal to about 24 hours.

In one aspect, the cell may be maintained at the first temperature for a time period greater than or equal to about 30 minutes to less than or equal to about 24 hours and cycled as the cell is cooled to room temperature.

In various aspects, the present disclosure provides a method for forming a solid-state battery. The method may include preparing a cell, heating the cell to a first temperature greater than or equal to about 50° C. to less than or equal to about 175° C., and cycling the cell while maintaining the cell at the first temperature. The cell may include a solid-state electrolyte adjacent to a lithium-metal foil. The solid-state battery incorporating the cell may have a total resistance greater than or equal to about 0.01 Ohm-cm² to less than or equal to about 1,000 Ohm-cm².

In one aspect, the cell may be cycled for greater than or equal to about 1 cycle to less than or equal to about 10 cycles.

In one aspect, while cycling, current densities may be greater than or equal to about 0.01 mA/cm² to less than or equal to about 10 mA/cm², and the capacity per cycle may be greater than or equal to about 0.01 mAh/cm² to less than or equal to about 1 mAh/cm².

In one aspect, the first temperature is maintained for a time period greater than or equal to about 30 minutes to less than or equal to about 24 hours.

In one aspect, the cell may be further cycled while the cell is cooled from the first temperature to room temperature.

In various aspects, the present disclosure provides a method for forming a solid-state battery. The method may include preparing a cell, heating the cell to a first temperature, maintaining the first temperature, and cycling the cell while the cell is cooled to room temperature from the first temperature. The cell may include a solid-state electrolyte adjacent to a lithium-metal foil. The solid-state battery incorporating the cell may have a total resistance greater than or equal to about 0.1 Ohm-cm² to less than or equal to about 1,000 Ohm-cm².

In one aspect, the first temperature may be greater than or equal to about 50° C. to less than or equal to about 175° C.

In one aspect, the first temperature may be maintained for a time period greater than or equal to about 30 minutes to less than or equal to about 24 hours.

In one aspect, the cell may be cycled for greater than or equal to about 1 cycle to less than or equal to about 10 cycles.

In one aspect, while cycling, current densities may be greater than or equal to about 0.01 mA/cm² to less than or equal to about 10 mA/cm², and capacity per cycle may be greater than or equal to about 0.01 mAh/cm² to less than or equal to about 1 mAh/cm².

In one aspect, the cell may be further cycled while the cell is maintained at the first temperature.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example solid-state battery including solid-state electrolyte and a lithium-metal anode;

FIG. 2A is a flowchart illustration of an example method for improving interfacial resistance between solid-state electrolytes and lithium-metal anodes, like the solid-state electrolyte and the lithium-metal anode illustrated in FIG. 1;

FIG. 2B is an illustration of an interface between an example solid-state electrolyte and lithium metal anode subjected to the method illustrated in FIG. 2A;

FIG. 3A is another example method for improving interfacial resistance between solid-state electrolyte layers and lithium-metal anodes, like the solid-state electrolyte and the lithium-metal anode illustrated in FIG. 1;

FIG. 3B is an illustration of an interface between an example solid-state electrolyte and lithium metal anode subject to the method illustrated in FIG. 3A;

FIG. 4 is a graphical illustration representing interfacial impedance of the example battery cells prepared in accordance with various aspects of the present disclosure;

FIG. 5 is a graphical illustration representing interfacial impedance of the example battery cells prepared in accordance with various aspects of the present disclosure; and

FIG. 6 is a graphical illustration representing the electrochemical impedance spectra of the example battery cells prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature’s relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs) and methods of forming and using the same. Solid-state batteries may include at least one solid component, for example, at least one solid electrode, but may also include, in certain variations, semi-solid or gel, liquid, or gas components. In various instances, solid-state batteries may have a bipolar stacking design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

In other variations, the solid-state batteries may have a monopolar stacking design comprising a plurality of monopolar electrodes where a first mixture of solid-state electroactive material particles (and optional solid-state electrolyte particles) is disposed on both a first side and a second side of a first current collector, wherein the first and second sides of the first current collector are substantially parallel, and a second mixture of solid-state electroactive material particles (and optional solid-state electrolyte particles) is disposed on both a first side and a second side of a second current collector, where the first and second sides of the second current collector are substantially parallel. The first mixture may include, as the solid-state electroactive material particles, cathode material particles. The second mixture may include, as solid-state electroactive material particles, anode material particles. The solid-state electrolyte particles in each instance may be the same or different. In certain variations, solid-state batteries may include a mixture of combination of bipolar and monopolar stacking designs.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

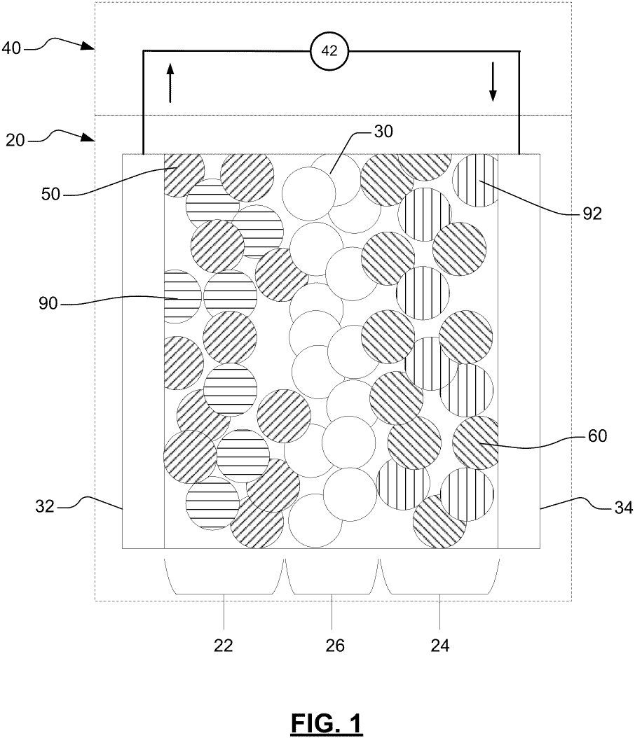

An exemplary and schematic illustration of a solid-state electrochemical cell unit (also referred to as a “solid-state battery” and/or “battery”) 20 that cycles lithium ions is shown in FIG. 1. The battery 20 includes a negative electrode (i.e., anode) 22, a positive electrode (i.e., cathode) 24, and an electrolyte layer 26 that occupies a space defined between the two or more electrodes. The electrolyte layer 26 is a solid-state or semi-solid state separating layer that physically separates the negative electrode 22 from the positive electrode 24. The electrolyte layer 26 may include a first plurality of solid-state electrolyte particles 30. In certain variations, a second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, so as to form a continuous electrolyte network, which may be a continuous lithium-ion conduction network.

A first current collector 32 may be positioned at or near the negative electrode 22. The first current collector 32 may be a metal foil, metal grid or screen, or expanded metal comprising copper or any other appropriate electrically conductive material known to those of skill in the art. A second current collector 34 may be positioned at or near the positive electrode 24. The second current collector 34 may be a metal foil, metal grid or screen, or expanded metal comprising aluminum or any other appropriate electrically conductive material known to those of skill in the art. The first current collector 32 and the second current collector 34 may be the same or different. The first current collector 32 and the second electrode current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34).

Although not illustrated, the skilled artisan will recognize that in certain variations, the first current collector 32 may be a first bipolar current collector and/or the second current collector 34 may be a second bipolar current collector. For example, the first bipolar current collector 34 and/or the second bipolar current collector 34 may be a cladded foil, for example, where one side (e.g., the first side or the second side) of the current collector 32, 34 includes one metal (e.g., first metal) and another side (e.g., the other side of the first side or the second side) of the current collector 32 includes another metal (e.g., second metal). The cladded foil may include, for example only, aluminum-copper (Al-Cu), nickel-copper (Ni-Cu), stainless steel-copper (SS-Cu), aluminum-nickel (Al-Ni), aluminum-stainless steel (Al-SS), and nickel-stainless steel (Ni-SS). In certain variations, the first bipolar current collector 32 and/or second bipolar current collectors 34 may be pre-coated, such as graphene or carbon-coated aluminum current collectors.

The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 towards the positive electrode 24. Lithium ions, which are also produced at the negative electrode 22, are concurrently transferred through the electrolyte layer 26 towards the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back towards the negative electrode 22 through the external circuit 40, and the lithium ions, which move across the electrolyte layer 26 back towards the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Though the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the electrolyte 26 layer.

In many configurations, each of the first current collector 32, the negative electrode 22, the electrolyte layer 26, the positive electrode 24, and the second current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, the positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and the third plurality of solid-state electrolyte particles 92. For example, the positive electrode 24 may include greater than or equal to about 30 wt.% to less than or equal to about 98 wt.%, and in certain aspects, optionally greater than or equal to about 50 wt.% to less than or equal to about 95 wt.%, of the positive solid-state electroactive particles 60, and greater than or equal to 0 wt.% to less than or equal to about 50 wt.%, and in certain aspects, optionally greater than or equal to about 5 wt.% to less than or equal to about 20 wt.%, of the third plurality of solid-state electrolyte particles 92. The positive electrode 24 may include greater than or equal to 30 wt.% to less than or equal to 98 wt.%, and in certain aspects, optionally greater than or equal to 50 wt.% to less than or equal to 95 wt.%, of the positive solid-state electroactive particles 60, and greater than or equal to 0 wt.% to less than or equal to 50 wt.%, and in certain aspects, optionally greater than or equal to 5 wt.% to less than or equal to 20 wt.%, of the third plurality of solid-state electrolyte particles 92.

The third plurality of solid-state electrolyte particles 92 may be the same as or different from the first and/or second pluralities of solid-state electrolyte particles 30, 90. In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0 ≤ x ≤ 1 and 0 ≤ y ≤ 1), LiNiₓMn_{y}Al_{1-x-y}O₂ (where 0 < x ≤ 1 and 0 < y ≤ 1), LiNiₓMn₁₋ₓO₂ (where 0 ≤ x ≤ 1), and Li₁₊ₓMO₂ (where 0 ≤ x ≤ 1) for solid-state lithium-ion batteries. The spinel cathode may include one or more positive electroactive materials, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. In this fashion, in various aspects, the positive solid-state electroactive particles 60 may comprise one or more positive electroactive materials selected from the group consisting of LiCoO₂, LiNiₓMn_{y}Co_{1-x-y}O₂ (where 0 ≤ x ≤ 1 and 0 ≤ y ≤ 1), LiNiₓMn₁₋ₓO₂ (where 0 ≤ x ≤ 1), Li₁₊ₓMO₂ (where 0 ≤ x < 1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

Although not illustrated, in certain variations, the positive electrode 24 may further include one or more conductive additives and/or binder materials. For example, the positive solid-state electroactive particles 60 (and/or third plurality of solid-state electrolyte particles 92) may be optionally intermingled with one or more electrically conductive materials (not shown) that provide an electron conduction path and/or at least one polymeric binder material (not shown) that improves the structural integrity of the positive electrode 24.

For example, the positive solid-state electroactive particles 60 (and/or third plurality of solid-state electrolyte particles 92) may be optionally intermingled with binders, like polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

The positive electrode 24 may include greater than or equal to 0 wt.% to less than or equal to about 30 wt.%, and in certain aspects, optionally greater than or equal to about 2 wt.% to less than or equal to about 10 wt.%, of the one or more electrically conductive additives; and greater than or equal to 0 wt.% to less than or equal to about 20 wt.%, and in certain aspects, optionally greater than or equal to about 1 wt.% to less than or equal to about 10 wt.%, of the one or more binders. The positive electrode 24 may include greater than or equal to 0 wt.% to less than or equal to 30 wt.%, and in certain aspects, optionally greater than or equal to 2 wt.% to less than or equal to 10 wt.%, of the one or more electrically conductive additives; and greater than or equal to 0 wt.% to less than or equal to 20 wt.%, and in certain aspects, optionally greater than or equal to 1 wt.% to less than or equal to 10 wt.%, of the one or more binders.

The solid-state electrolyte layer 26 provides electrical separation— preventing physical contact—between the negative electrode 22 and the positive electrode 24. The solid-state electrolyte layer 26 also provides a minimal resistance path for internal passage of ions. In various aspects, the solid-state electrolyte layer 26 may be defined by a first plurality of solid-state electrolyte particles 30. For example, as illustrated, the solid-state electrolyte layer 26 may be in the form of a layer or a composite that comprises the first plurality of solid-state electrolyte particles 30.

The solid-state electrolyte layer 26 may be in the form of a layer having a thickness greater than or equal to about 5 µm to less than or equal to about 200 µm, optionally greater than or equal to about 10 µm to less than or equal to about 100 µm, optionally about 40 µm, and in certain aspects, optionally about 30 µm. The solid-state electrolyte layer 26 may be in the form of a layer having a thickness greater than or equal to 5 µm to less than or equal to 200 µm, optionally greater than or equal to 10 µm to less than or equal to 100 µm, optionally 40 µm, and in certain aspects, optionally 30 µm.

The solid-state electrolyte particles 30 may have an average particle diameter greater than or equal to about 0.02 µm to less than or equal to about 20 µm, optionally greater than or equal to about 0.1 µm to less than or equal to about 10 µm, and in certain aspects, optionally greater than or equal to about 0.1 µm to less than or equal to about 1 µm. The solid-state electrolyte particles 30 may have an average particle diameter greater than or equal to 0.02 µm to less than or equal to 20 µm, optionally greater than or equal to 0.1 µm to less than or equal to 10 µm,and in certain aspects, optionally greater than or equal to 0.1 µm to less than or equal to 1 µm.

The solid-state electrolyte particles 30 may comprise one or more sulfide-based particles, oxide-based particles, metal-doped or aliovalent-substituted oxide particles, nitride-based particles, hydride-based particles, halide-based particles, and borate-based particles.

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The LISICON-type oxides may be selected from the group consisting of: Li₂₊₂ₓZn₁₋ₓGeO₄ (where 0 < x < 1), Li₁₄Zn(GeO₄)₄, Li₃₊ₓ(P₁₋ₓSiₓ)O₄ (where 0 < x < 1), Li₃₊ₓGeₓV₁₋ₓO₄ (where 0 < x < 1), and combinations thereof. The NASICON-type oxides may be defined by LiMM′(PO₄)₃, where M and M′ are independently selected from Al, Ge, Ti, Sn, Hf, Zr, and La. For example, in certain variations, the NASICON-type oxides may be selected from the group consisting of: Li₁₊ₓAlₓGe₂₋ₓ(PO₄)₃ (LAGP) (where 0 < x < 2), Li_{1.4}Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The Perovskite-type ceramics may be selected from the group consisting of: Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x = 0.75y and 0.60 < y < 0.75), Li_{⅜}Sr_{7/16}Nb_{¾}Zr_{¼}O₃, Li₃ₓLa_{(⅔-x)}TiO₃ (where 0 < x < 0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0 < x < 2 and 0 < y < 3), and combinations thereof.

In certain variations, the sulfide-based particles may include, for example only, a pseudobinary sulfide, a pseudoternary sulfide, and/or a pseudoquaternary sulfide. Example pseudobinary sulfide systems include Li₂S-P₂S₅ systems (such as, Li₃PS₄, Li₇P₃S₁₁, and Li_{9.6}P₃S₁₂), Li₂S-SnS₂ systems (such as, Li₄SnS₄), Li₂S-SiS₂ systems, Li₂S-GeS₂ systems, Li₂S-B₂S₃ systems, Li₂S-Ga₂S₃ system, Li₂S-P₂S₃ systems, and Li₂S-Al₂S₃ systems. Example pseudoternary sulfide systems include Li₂O-Li₂S-P₂S₅ systems, Li₂S-P₂S₅-P₂O₅ systems, Li₂S-P₂S₅-GeS₂ systems (such as, Li_{3.25}Ge_{0.25}P_{0.75}S₄ and Li₁₀GeP₂S₁₂), Li₂S-P₂S₅-LiX systems (where X is one of F, Cl, Br, and I) (such as, Li₆PS₅Br, Li₆PS₅Cl, L₇P₂S₈I, and Li₄PS₄I), Li₂S-As₂S₅-SnS₂ systems (such as, Li_{3.833}Sn_{0.833}As_{0.166}S₄), Li₂S-P₂S₅-Al₂S₃ systems, Li₂S-LiX-SiS₂ systems (where X is one of F, Cl, Br, and I), 0.4LiI-0.6Li₄SnS₄, and Li₁₁Si₂PS₁₂. Example pseudoquaternary sulfide systems include Li₂O-Li₂S-P₂S₅₋P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

In certain variations, the nitride-based particles may include, for example only, Li3N, Li₇PN₄, LiSi₂N₃, and combinations thereof; the hydride-based particles may include, for example only, LiBH4, LiBH₄-LiX (where x = Cl, Br, or I), LiNH₂, Li₂NH, LiBH₄-LiNH₂, Li₃AlH₆, and combinations thereof; the halide-based particles may include, for example only, LiI, +Li₃InCl₆, Li₂CdC₁₄, Li₂MgCl₄, LiCdI₄, Li₂ZnI₄, Li₃OCl, Li₃YCl₆, Li₃YBr₆, and combinations thereof; and the borate-based particles may include, for example only, Li₂B₄O₇, Li₂O-B₂O₃-P₂O₅, and combinations thereof.

In various aspects, the first plurality of solid-state electrolyte particles 30 may include one or more electrolyte materials selected from the group consisting of: Li₂S-P₂S₅ system, Li₂S-P₂S₅-MOₓ system (where 1 < x < 7), Li₂S-P₂S₅-MSₓ system (where 1 < x < 7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1-x)P₂S₅-xLi₂S (where 0.5 ≤ x < 0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₂₊₂ₓZn₁₋ₓGeO₄ (where 0 < x < 1), Li₁₄Zn(GeO₄)₄, Li₃₊ₓ(P₁₋ₓSiₓ)O₄ (where 0 < x < 1), Li₃₊ₓGeₓV₁₋ₓO₄ (where 0 < x < 1), LiMM′(PO₄)₃ (where M and M′ are independently selected from Al, Ge, Ti, Sn, Hf, Zr, and La), Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x = 0.75y and 0.60 < y < 0.75), Li_{⅜}Sr_{7/16}Nb_{¾}Zr_{¼}O₃, Li₃ₓLa_{(⅔-x})TiO₃ (where 0 < x < 0.25), aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0 < x < 2 and 0 < y < 3), LiI-Li₄SnS₄, Li₄SnS₄, Li₃N, Li₇PN₄, LiSi₂N₃, LiBH₄, LiBH₄-LiX (where x = Cl, Br, or I), LiNH₂, Li₂NH, LiBH₄-LiNH₂, Li₃AlH₆, LiI, Li₃InCl₆, Li₂CdC₁₄, Li₂MgCl₄, LiCdI₄, Li₂ZnI₄, Li₃OCl, Li₂B₄O₇, Li₂O-B₂O₃₋P₂O₅, and combinations thereof.

In certain variations, the first plurality of solid-state electrolyte particles 30 may include one or more electrolyte materials selected from the group consisting of: Li₂S-P₂S₅ system, Li₂S-P₂S₅-MOₓ system (where 1 < x < 7), Li₂S-P₂S₅-MSₓ system (where 1 < x < 7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1-x)P₂S₅-xLi₂S (where 0.5 ≤ x < 0.7), Li_{3.4}Si_{0.4}P_{0.6}S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, and combinations thereof.

Although not illustrated, the skilled artisan will recognize that in certain instances, one or more binder particles may be mixed with the solid-state electrolyte particles 30. For example, in certain aspects the solid-state electrolyte layer 26 may include greater than or equal to about 0 wt.% to less than or equal to about 10 wt.%, and in certain aspects, optionally greater than or equal to about 0.5 wt.% to less than or equal to about 10 wt.%, of the one or more binders. The one or more polymeric binders may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), and lithium polyacrylate (LiPAA).

In certain instances, the solid-state electrolyte particles 30 (and the optionally one or more binder particles) may be wetted by a small amount of liquid electrolyte, for example, to improve ionic conduction between the solid-state electrolyte particles 30. The solid-state electrolyte particles 30 may be wetted by greater than or equal to about 0 wt.% to less than or equal to about 40 wt.%, optionally greater than or equal to about 0.1 wt.% to less than or equal to about 40 wt.%, and in certain aspects, optionally greater than or equal to about 5 wt.% to less or equal to about 10 wt.%, of the liquid electrolyte, based on the weight of the solid-state electrolyte particles 30. In certain variations, Li₇P₃S₁₁ may be wetted by an ionic liquid electrolyte including LiTFSI-triethylene glycol dimethyl ether.

The negative electrode 22 may be formed from a lithium host material that is capable of functioning as a negative terminal of a lithium-ion battery. In various aspects, the negative electrode 22 may include a negative electroactive material that comprises lithium. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and the second plurality of solid-state electrolyte particles 90. In each variation, the negative electrode 22 may be in the form of a layer having a thickness greater than or equal to about 10 µm to less than or equal to about 5,000 µm, and in certain aspects, optionally greater than or equal to about 10 µm to less than or equal to about 100 µm. The negative electrode 22 may be in the form of a layer having a thickness greater than or equal to 10 µm to less than or equal to 5,000 µm, and in certain aspects, optionally greater than or equal to 10 µm to less than or equal to 100 µm.

The negative electrode 22 may include greater than or equal to about 30 wt.% to less than or equal to about 98 wt.%, and in certain aspects, optionally greater than or equal to about 50 wt.% to less than or equal to about 95 wt.%, of the negative solid-state electroactive particles 50, and greater than or equal to 0 wt.% to less than or equal to about 50 wt.%, and in certain aspects, optionally greater than or equal to about 5 wt.% to less than or equal to about 20 wt.%, of the second plurality of solid-state electrolyte particles 90. The negative electrode 22 may include greater than or equal to 30 wt.% to less than or equal to 98 wt.%, and in certain aspects, optionally greater than or equal to 50 wt.% to less than or equal to 95 wt.%, of the negative solid-state electroactive particles 50, and greater than or equal to 0 wt.% to less than or equal to 50 wt.%, and in certain aspects, optionally greater than or equal to 5 wt.% to less than or equal to 20 wt.%, of the second plurality of solid-state electrolyte particles 90.

The second plurality of solid-state electrolyte particles 90 may be the same as or different from the first plurality of solid-state electrolyte particles 30. In various aspects, the negative solid-state electroactive particles 50 may be lithium-based, for example, a lithium alloy (e.g., LiSiₓ, LiAlₓ, LiSnₓ, and/or LiGeₓ) or a lithium metal. For example, although not illustrated, in certain variations, the negative electrode may be a film or layer formed of lithium metal. In such instances, the lithium metal foil may have a thickness greater than or equal to about 0 nm to less than or equal to about 200 µm, and in certain aspects, optionally greater than or equal to about 5 µm to less than or equal to about 50 µm.

In other variations, the negative solid-state electroactive particles 50 may be silicon-based comprising, for example, a silicon alloy and/or silicon-graphite mixture. In still other variations, the negative electrode 22 may be a carbonaceous anode and the negative solid-state electroactive particles 50 may comprise one or more negative electroactive materials, such as graphite, graphene, hard carbon, soft carbon, and carbon nanotubes (CNTs). In certain variations, the negative electroactive material may include a carbonaceous-silicon based composite including, for example, about 10 wt.% SiOₓ (where 0 ≤ x ≤ 2) and about 90 wt.% graphite.

Although not illustrated, in certain variations, the negative electrode 22 may further include one or more conductive additives and/or binder materials. For example, the negative solid-state electroactive particles 50 (and/or second plurality of solid-state electrolyte particles 90) may be optionally intermingled with one or more electrically conductive materials (not shown) that provide an electron conduction path and/or at least one polymeric binder material (not shown) that improves the structural integrity of the negative electrode 22.

For example, the negative solid-state electroactive particles 50 (and/or second plurality of solid-state electrolyte particles 90) may be optionally intermingled with binders, such as sodium carboxymethyl cellulose (CMC), styrene ethylene butylene styrene copolymer (SEBS), styrene butadiene styrene copolymer (SBS), polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon nanofibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

In various aspects, the negative electrode 22 may include greater than or equal to 0 wt.% to less than or equal to about 30 wt.%, and in certain aspects, optionally greater than or equal to about 2 wt.% to less than or equal to about 10 wt.%, of the one or more electrically conductive additives; and greater than or equal to 0 wt.% to less than or equal to about 20 wt.%, and in certain aspects, optionally greater than or equal to about 1 wt.% to less than or equal to about 10 wt.%, of the one or more binders. The negative electrode 22 may include greater than or equal to 0 wt.% to less than or equal to 30 wt.%, and in certain aspects, optionally greater than or equal to 2 wt.% to less than or equal to 10 wt.%, of the one or more electrically conductive additives; and greater than or equal to 0 wt.% to less than or equal to 20 wt.%, and in certain aspects, optionally greater than or equal to 1 wt.% to less than or equal to 10 wt.%, of the one or more binders.

In various aspects, the present disclosure provides methods for improving interfacial resistance between solid-state electrolyte layers and negative electrodes, like the solid-state electrolyte layer 26 and the negative electrode 22 illustrated in FIG. 1. Methods may generally include contacting the negative electrode and a solid-state electrolyte and heating (e.g., baking) the combined structure at a predetermined temperature for a predetermined time period.

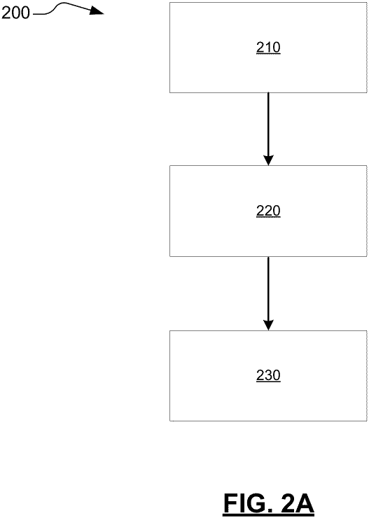

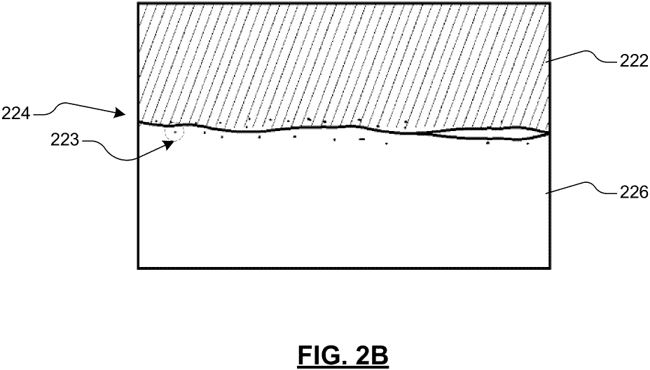

An example method 200 for improving the interfacial resistance between a solid-state electrolyte layer and a negative electrode is illustrated in FIG. 2A. In certain variations, the solid-state electrolyte may be a free-standing membrane, and the negative electrode may be a lithium-metal anode. The method 200 may include contacting 220 a lithium metal foil and a solid-state electrolyte, and heating (e.g., baking) 230 the combined structure. For example, the combine structure may be heated 230 to a temperature greater than or equal to about 50° C. to less than or equal to about 175° C., and in certain aspects, optionally greater than or equal to about 100° C. to less than or equal to about 175° C., for a time period greater than or equal to about 30 minutes to less than or equal to about 24 hours, and in certain aspects, optionally, greater than or equal to about 1 hours to less than or equal to about 5 hours, where greater the temperature the shorter the time period. The combine structure may be heated 230 to a temperature greater than or equal to 50° C. to less than or equal to 175° C., and in certain aspects, optionally greater than or equal to 100° C. to less than or equal to 175° C., for a time period greater than or equal to 30 minutes to less than or equal to 24 hours, and in certain aspects, optionally, greater than or equal to 1 hours to less than or equal to 5 hours, where greater the temperature the shorter the time period.

In certain variations, the method 200 may include preparing 210 the solid-state electrolyte and/or the lithium metal foil, and in still other variations, although not illustrated, the method 200 may include contacting the solid-state electrolyte, the negative electrode (i.e., lithium metal foil), and a positive electrode in sequence, and under pressure, to form a battery cell, and the method may include contacting one or more cells to form a battery. That is, in various aspects, the lithium metal foil and the solid-state electrolyte may be contacted in sealed cells, and the heating may occur in atmospheric conditions. In other variations, the lithium metal foil and the solid-state electrolyte may be contacted in a glove box prior to cell assembly.

In each variation, as illustrated in FIG. 2B, heating the interface to a temperature greater than or equal to about 50° C. to less than or equal to about 175° C., and in certain aspects, optionally greater than or equal to about 100° C. to less than or equal to about 175° C., for a time period greater than or equal to about 30 minutes to less than or equal to about 24 hours, and in certain aspects, optionally, greater than or equal to about 1 hour to less than or equal to about 5 hours, improves an interface 224 (for example, contact area) between a lithium metal anode 222 and a solid-state electrolyte layer 226. For example, the elevated temperature may soften the lithium metal allowing for metal deformity and increased contact are coverage. As illustrated, the solid-state electrolyte layer 226 contacts greater than or equal to about 50 % to less than or equal to about 100 %, and in certain aspects, optionally greater than or equal to 50 % to less than or equal to 100 %, of a total surface of the lithium metal anode 222.

In certain variations, as illustrated, one or more impurities 223 (e.g., Li2O and/or Li₂CO₃) may be dispersed along the interface between the solid-state electrolyte layer 226 and the lithium metal anode 222 and/or within one or both of the solid-state electrolyte 226 and/or the lithium metal anode 222. For example, the solid-state electrolyte 226 and/or lithium metal anode 222 may include greater than or equal to 0 wt.% to less than or equal to about 10 wt.%, optionally greater than or equal to 0 wt.% to less than or equal to about 5 wt.%, optionally greater than or equal to 0 wt.% to less than or equal to about 2 wt.%, and in certain aspects, optionally greater than or equal to 0 wt.% to less than or equal to about 1 wt.%, of the one or more impurities 223.

A total resistance of the cell including the lithium metal anode 222 and the solid-state electrolyte layer 226 may be greater than or equal to about 0.01 Ohm-cm² to less than or equal to about 76,000 Ohm-cm², greater than or equal to about 0.1 Ohm-cm² to less than or equal to about 76,000 Ohm-cm², and in certain aspects, greater than or equal to about 0.05 Ohm-cm² to less than or equal to about 1,000 Ohm-cm². A total resistance of the cell including the lithium metal anode 222 and the solid-state electrolyte layer 226 may be greater than or equal to 0.01 Ohm-cm² to less than or equal to 76,000 Ohm-cm², greater than or equal to 0.1 Ohm-cm² to less than or equal to 76,000 Ohm-cm², and in certain aspects, greater than or equal to 0.05 Ohm-cm² to less than or equal to 1,000 Ohm-cm². In

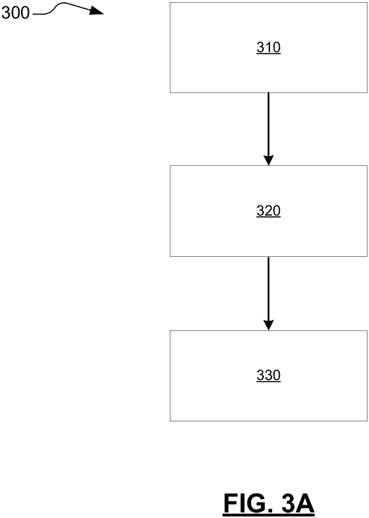

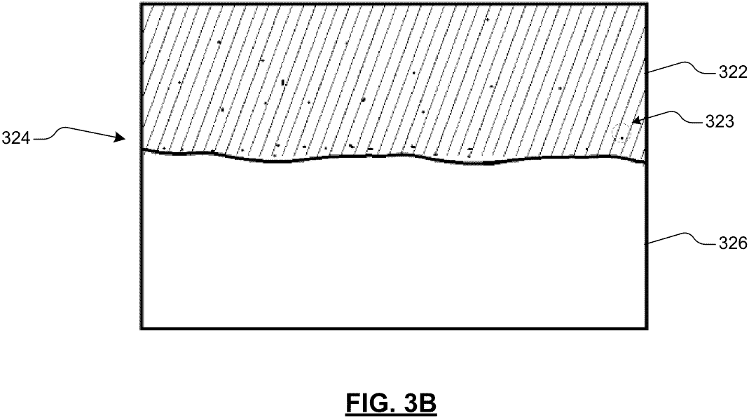

FIG. 3A provides another method 300 for improving interfacial resistance between solid-state electrolyte layers and lithium-metal anodes, like the solid-state electrolyte layer 26 and the negative electrode 22 illustrated in FIG. 1. In various aspects, method 300 may include preparing 310 a sealed cell, including a lithium metal foil and a solid-state electrolyte; heating (e.g., baking) 320 the cell to a first temperature; and cycling 330 the cell while the cell is maintained at the first temperature and/or as the cell returns to room temperature (e.g., about 20° C., optionally about 21° C.) from the first temperature. At the higher temperatures (e.g., between the first temperature and room temperature), and in certain instances, higher pressures, the lithium metal softens and easily fills voids along the electrolyte-electrode interface, for example as a result of plastic flow properties.

In each variation, the first temperature may be greater than or equal to about 50° C. to less than or equal to about 175° C., and in certain aspects, optionally greater than or equal to about 100° C. to less than or equal to about 175° C. The first temperature may be greater than or equal to 50° C. to less than or equal to 175° C., and in certain aspects, optionally greater than or equal to 100° C. to less than or equal to 175° C. The cell may be cycled for greater than or equal to about 1 cycle to less than or equal to about 10 cycles, and in certain aspects, optionally greater than or equal to 1 cycle to less than or equal to 10 cycles, when the current densities are greater than or equal to about 0.01 mA/cm² to less than or equal to about 10 mA/cm², and in certain aspects, optionally greater than or equal to 0.01 mA/cm² to less than or equal to 10 mA/cm², and the capacity per cycle is greater than or equal to about 0.01 mAh/cm² to less than or equal to about 1 mAh/cm², and in certain aspects, optionally greater than or equal to 0.01 mAh/cm² to less than or equal to 1 mAh/cm².

As illustrated in FIG. 3B, cycling cells at an elevated temperature improves an interface (for example, contact area) between a lithium metal anode 322 and a solid-state electrolyte layer 326. For example, a contact area between the lithium metal anode 322 and the solid-state electrolyte layer 326 may see an improvement of greater than or equal to about 30 % to less than or equal to about 100 %, and in certain aspects, optionally greater than or equal to about 90 % to less than or equal to about 100 %. The contact area between the lithium metal anode 322 and the solid-state electrolyte layer 326 may see an improvement of greater than or equal to 30 % to less than or equal to 100 %, and in certain aspects, optionally greater than or equal to 90 % to less than or equal to 100 %. A total resistance of the cell including the lithium metal anode 322 and the solid-state electrolyte layer 326 may be greater than or equal to about 0.01 Ohm-cm² to less than or equal to about 1,000 Ohm-cm², greater than or equal to about 0.05 Ohm-cm² to less than or equal to about 1,000 Ohm-cm², and in certain aspects, greater than or equal to about 0.1 Ohm-cm² to less than or equal to about 5 Ohm-cm². The total resistance including the lithium metal anode 322 and the solid-state electrolyte layer 326 may be greater than or equal to 0.05 Ohm-cm² to less than or equal to 1,000 Ohm-cm², greater than or equal to 0.05 Ohm-cm² to less than or equal to 1,000 Ohm-cm², and in certain aspects, greater than or equal to 0.1 Ohm-cm² to less than or equal to 5 Ohm-cm².

In certain variations, as illustrated, one or more impurities 323 (e.g., Li2O and/or Li₂CO₃) may be dispersed along the interface between the solid-state electrolyte layer 326 and the lithium metal anode 322 and/or within one or both of the solid-state electrolyte 326 and/or the lithium metal anode 322. For example, the solid-state electrolyte 326 and/or lithium metal anode 322 may include greater than or equal to 0 wt.% to less than or equal to about 10 wt.%, optionally greater than or equal to 0 wt.% to less than or equal to about 5 wt.%, optionally greater than or equal to 0 wt.% to less than or equal to about 2 wt.%, and in certain aspects, optionally greater than or equal to 0 wt.% to less than or equal to about 1 wt.%, of the one or more impurities 323.

Although not illustrated, in certain aspects, cycling cells at an elevated temperature may cause lithium metal to be electrochemically plated onto a surface of the solid-state electrolyte layer 326 opposing the lithium metal anode 322. For example, a precursor cell may be prepared having a symmetric structure, where two lithium metal electrodes are disposed on or adjacent to parallel sides of the solid electrolyte layer 326. A current may be applied, which travels through the solid electrolyte layer 326 and plates lithium onto the surface of the solid-state electrolyte layer 326 opposing the lithium metal anode 322. The electrochemically plated lithium metal may cover greater than or equal to about 50% to less than or equal to about 100%, and in certain aspects, optionally cover greater than or equal to 50% to less than or equal to 100%, of a total surface of the solid-state electrolyte layer 326.

Certain features of the current technology are further illustrated in the following non-limiting examples.

### Example I

Example battery cells may be prepared in accordance with various aspects of the present disclosure.

For example, an example battery cell 410 may include a solid-state electrolyte layer and a lithium metal anode heated to a temperature may be greater than or equal to about 50° C. to less than or equal to about 175° C., where the temperature is maintained for about 4 hours.

Another example battery cell 420 may include a solid-state electrolyte layer and a lithium metal anode heated to a temperature may be greater than or equal to about 50° C. to less than or equal to about 175° C., where the temperature is maintained for about 8 hours.

Another example battery cell 430 may include a solid-state electrolyte layer and a lithium metal anode heated to a temperature may be greater than or equal to about 50° C. to less than or equal to about 175° C., where the temperature is maintained for about 12 hours.

Another example battery cell 440 may include a solid-state electrolyte layer and a lithium metal anode heated to a temperature may be greater than or equal to about 50° C. to less than or equal to about 175° C., where the temperature is maintained for about 16 hours.

Another example battery cell 450 may include a solid-state electrolyte layer and a lithium metal anode heated to a temperature may be greater than or equal to about 50° C. to less than or equal to about 175° C., where the temperature is maintained for about 20 hours.

A comparative battery cell 460 includes a solid-state electrolyte layer and a lithium metal anode, which is not subjected to a heating step.

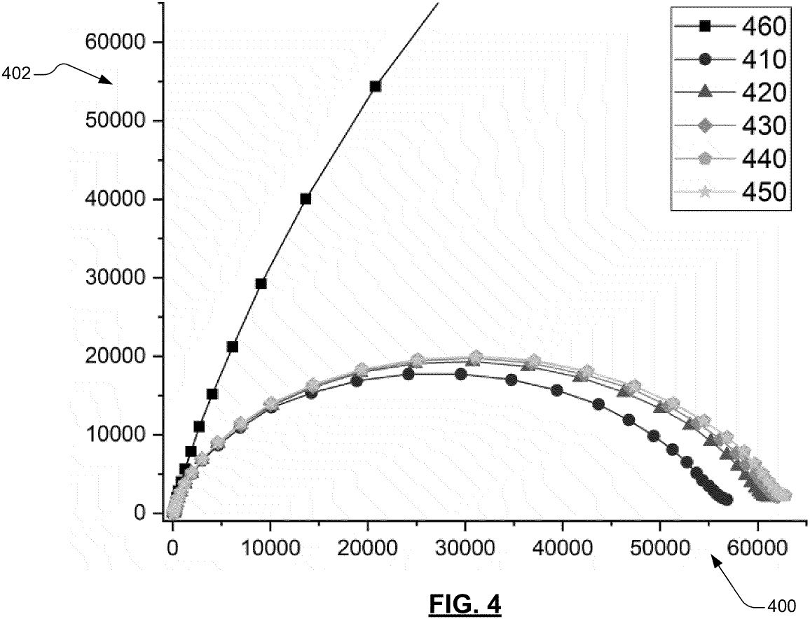

FIG. 4 is a graphical illustration representing interfacial impedance of the example battery cells 410, 420, 430, 440, 450 as compared to the comparative battery 460, where the x-axis 400 represents Z′ (Ω·cm²) and the y-axis 402 represents -Z″ (Ω·cm²).

### Example II

Example battery cells may be prepared in accordance with various aspects of the present disclosure.

For example, an example battery cell 510 may include a solid-state electrolyte layer and a lithium metal anode heated to a temperature may be greater than or equal to about 50° C. to less than or equal to about 175° C., where the temperature is maintained for about 20 hours and cycled thereafter. For example, the example battery cell 510 may be cycled for greater than or equal to about 1 cycle to less than or equal to about 10 cycles, when the current densities are greater than or equal to about 0.01 mA/cm² to less than or equal to about 10 mA/cm², and the capacity per cycle is greater than or equal to about 0.01 mAh/cm² to less than or equal to about 1 mAh/cm².

An comparative battery cell 520 may include a solid-state electrolyte layer and a lithium metal anode heated to a temperature may be greater than or equal to about 50° C. to less than or equal to about 175° C., where the temperature is maintained for about 20 hours, but not cycled.

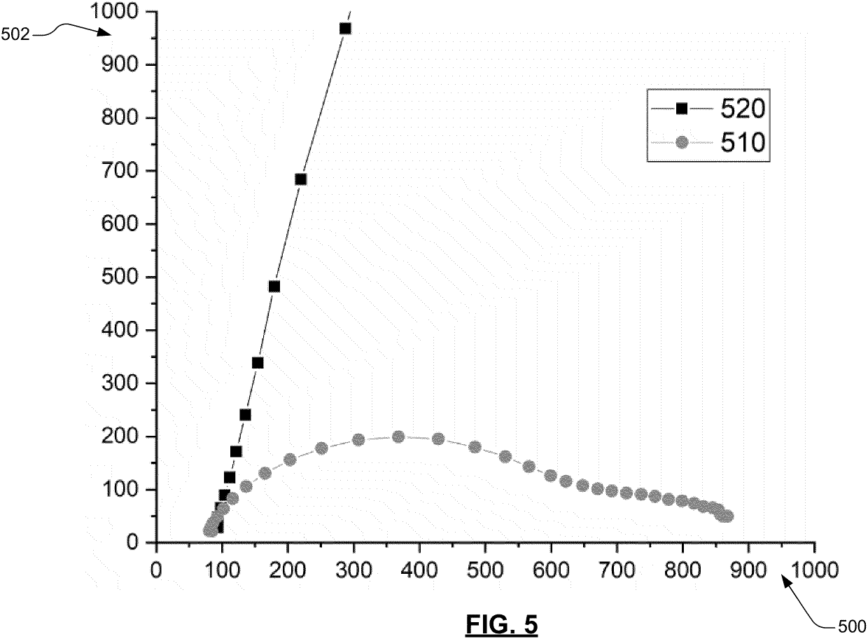

FIG. 5 is a graphical illustration representing interfacial impedance of the example battery cell 510 as compared to the comparative battery 520, where the x-axis 500 represents Z′ (Ω·cm²) and the y-axis 502 represents -Z″ (Ω·cm²). A total resistance for the example battery cell 510 may be about 1,047 \.353 Ohm-cm², while a total resistance for the comparative battery cell 520 may be about 75,695 \.60201 Ohm-cm².

### Example III

Example battery cells may be prepared in accordance with various aspects of the present disclosure

For example, an example battery cell 610 may include a solid-state electrolyte layer and a lithium metal anode heated to about 170° C., where the temperature is maintained for about 4 hours and cycled thereafter. For example, the example battery cell 610 may be cycled for greater than or equal to about 1 cycle to less than or equal to about 10 cycles, when the current densities are greater than or equal to about 0.01 mA/cm² to less than or equal to about 10 mA/cm², and the capacity per cycle is greater than or equal to about 0.01 mAh/cm² to less than or equal to about 1 mAh/cm².

An example battery cell 620 may include a solid-state electrolyte layer and a lithium metal anode heated to about 170° C., where the temperature is maintained for about 8 hours and cycled thereafter. For example, the example battery cell 610 may be cycled for greater than or equal to about 1 cycle to less than or equal to about 10 cycles, when the current densities are greater than or equal to about 0.01 mA/cm² to less than or equal to about 10 mA/cm², and the capacity per cycle is greater than or equal to about 0.01 mAh/cm² to less than or equal to about 1 mAh/cm².

An example battery cell 630 may include a solid-state electrolyte layer and a lithium metal anode heated to about 170° C., where the temperature is maintained for about 12 hours and cycled thereafter. For example, the example battery cell 610 may be cycled for greater than or equal to about 1 cycle to less than or equal to about 10 cycles, when the current densities are greater than or equal to about 0.01 mA/cm² to less than or equal to about 10 mA/cm², and the capacity per cycle is greater than or equal to about 0.01 mAh/cm² to less than or equal to about 1 mAh/cm².

An example battery cell 640 may include a solid-state electrolyte layer and a lithium metal anode heated to about 170° C., where the temperature is maintained for about 16 hours and cycled thereafter. For example, the example battery cell 610 may be cycled for greater than or equal to about 1 cycle to less than or equal to about 10 cycles, when the current densities are greater than or equal to about 0.01 mA/cm² to less than or equal to about 10 mA/cm², and the capacity per cycle is greater than or equal to about 0.01 mAh/cm² to less than or equal to about 1 mAh/cm².

An example battery cell 650 may include a solid-state electrolyte layer and a lithium metal anode heated to about 170° C., where the temperature is maintained for about 20 hours and cycled thereafter. For example, the example battery cell 610 may be cycled for greater than or equal to about 1 cycle to less than or equal to about 10 cycles, when the current densities are greater than or equal to about 0.01 mA/cm² to less than or equal to about 10 mA/cm², and the capacity per cycle is greater than or equal to about 0.01 mAh/cm² to less than or equal to about 1 mAh/cm².

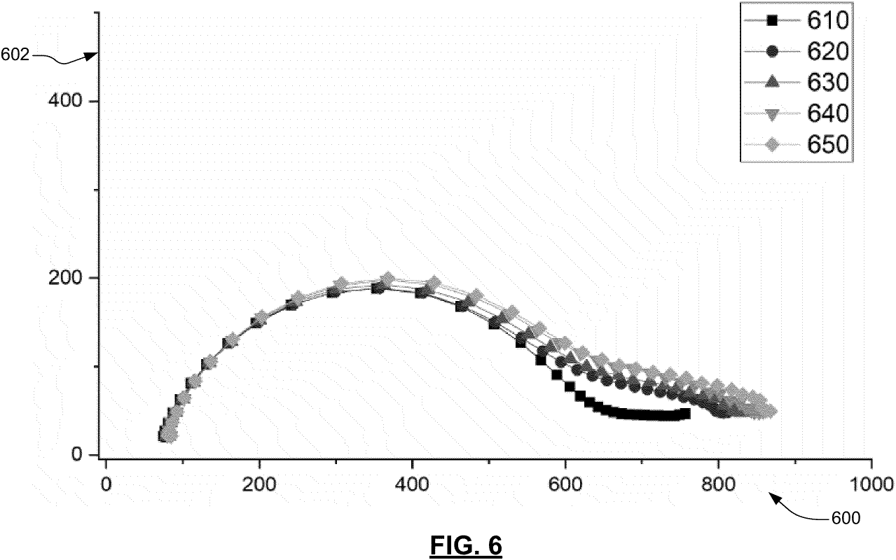

FIG. 6 is a graphical illustration representing the electrochemical impedance spectra of the example battery cells 610, 620, 630, 640, 650, where the x-axis 600 represents Z′ (Ω·cm² ) and the y-axis 602 represents -Z″ (Ω·cm²).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for forming a solid-state battery, the method comprising:
preparing a cell, the cell comprising a solid-state electrolyte adjacent to a negative electrode;
heating the cell to a first temperature; and
cycling the cell while maintaining the cell at the first temperature and/or while the cell is cooled to room temperature from the first temperature, wherein the solid-state battery incorporating the cell has a total resistance greater than or equal to about 0.01 Ohm-cm² to less than or equal to about 1,000 Ohm-cm².

2. The method of claim 1, wherein the negative electrode comprises one or more negative electroactive materials selected from the group consisting of: lithium metal, lithium alloys, silicon, silicon alloys, and combinations thereof.

3. The method of claim 2, wherein the negative electrode comprises a lithium-metal foil.

4. The method of claim 1, wherein the first temperature greater than or equal to about 50° C. to less than or equal to about 175° C.

5. The method of claim 1, wherein the cell is cycled for greater than or equal to about 1 cycle to less than or equal to about 10 cycles.

6. The method of claim 1, wherein while cycling, current densities are greater than or equal to about 0.01 mA/cm² to less than or equal to about 10 mA/cm².

7. The method of claim 1, wherein while cycling, capacity per cycle is greater than or equal to about 0.01 mAh/cm² to less than or equal to about 1 mAh/cm².

8. The method of claim 1, wherein the cell is cycled while the cell is maintained at the first temperature, and the cell is maintained at the first temperature for a time period greater than or equal to about 30 minutes to less than or equal to about 24 hours.

9. The method of claim 1, wherein the cell is maintained at the first temperature for a time period greater than or equal to about 30 minutes to less than or equal to about 24 hours and cycled as the cell is cooled to room temperature.

10. A method for forming a solid-state battery, the method comprising:
preparing a cell, the cell comprising a solid-state electrolyte adjacent to a lithium-metal foil;
heating the cell to a first temperature greater than or equal to about 50° C. to less than or equal to about 175° C.; and
cycling the cell while maintaining the cell at the first temperature, wherein the solid-state battery incorporating the cell has a total resistance greater than or equal to about 0.01 Ohm-cm² to less than or equal to about 1,000 Ohm-cm².

11. The method of claim 10, wherein the cell is cycled for greater than or equal to about 1 cycle to less than or equal to about 10 cycles.

12. The method of claim 10, wherein while cycling, current densities are greater than or equal to about 0.01 mA/cm² to less than or equal to about 10 mA/cm², and the capacity per cycle is greater than or equal to about 0.01 mAh/cm² to less than or equal to about 1 mAh/cm².

13. The method of claim 10, wherein the first temperature is maintained for a time period is greater than or equal to about 30 minutes to less than or equal to about 24 hours.

14. The method of claim 10, wherein the cell is further cycled while the cell is cooled from the first temperature to room temperature.

15. A method for forming a solid-state battery, the method comprising:
preparing a cell, the cell comprising a solid-state electrolyte adjacent to a lithium-metal foil;
heating the cell to a first temperature;
maintaining the first temperature; and
cycling the cell while the cell is cooled to room temperature from the first temperature, wherein the solid-state battery incorporating the cell has a total resistance greater than or equal to about 0.1 Ohm-cm² to less than or equal to about 1,000 Ohm-cm².

16. The method of claim 15, wherein the first temperature greater than or equal to about 50° C. to less than or equal to about 175° C.

17. The method of claim 15, wherein the first temperature is maintained for a time period greater than or equal to about 30 minutes to less than or equal to about 24 hours.

18. The method of claim 15, wherein the cell is cycled for greater than or equal to about 1 cycle to less than or equal to about 10 cycles.

19. The method of claim 15, wherein while cycling, current densities are greater than or equal to about 0.01 mA/cm² to less than or equal to about 10 mA/cm², and capacity per cycle is greater than or equal to about 0.01 mAh/cm² to less than or equal to about 1 mAh/cm².

20. The method of claim 15, wherein the cell is further cycled while the cell is maintained at the first temperature.
